(19) United States
(12) Patent Application Publication
(10) Pub. No.: US 2011/0155030 A1
(43) Pub. Date: Jun. 30, 2011

(54) SYSTEM AND METHOD FOR PLANTING SEED USING A MULTI-WAY SEED SAMPLE SPLITTER

(75) Inventors: Daniel M. Goldman, Des Moines, IA (US); Jason J. Kelsick, Alleman, IA (US)

(73) Assignee: Pioneer Hi-Bred International, Inc.

(21) Appl. No.: 12/979,033

(22) Filed: Dec. 27, 2010

Related U.S. Application Data
(60) Provisional application No. 61/290,394, filed on Dec. 28, 2009.

(51) Int. Cl. A01C 7/08

(52) U.S. Cl. 111/170

(57) ABSTRACT

Various embodiments of a seed planting system and method of the present invention are configured to receive a seed sample and split the seed sample into three or more substantially equal divisions for delivery to a seed planting device. In particular, the seed planting system and method of the present invention split the seed sample by first dividing the seed sample into a plurality of subsamples equal to a whole number multiple of the number of desired divisions and then symmetrically recombining the subsamples into the equal divisions. The divisions are then delivered to respective individual row planters of the seed planting device. By dividing the seed sample into a plurality of subsamples and then symmetrically recombining the subsamples, the seed planting system and method of the present invention may generate substantially equal divisions irrespective of the orientation or tilt of the seed planting device.

### CROSS-REFERENCE TO RELATED APPLICATIONS

The present application claims priority from U.S. Provisional Application No. 61/290,394 filed Dec. 28, 2009, which is hereby incorporated herein by reference in its entirety.

### FIELD OF THE INVENTION

The various embodiments of the present invention generally relate to a system and method for planting seed. More specifically, embodiments of the present invention relate to a system and method for planting seed using multi-way seed sample splitter.

### BACKGROUND OF THE INVENTION

It is typical for a company in the agricultural seed industry to generate one or more research plots in order to evaluate certain seed varieties. Such seed varieties may include, but need not be limited to, seeds from a specific source, genotype, population, and/or breeding line. In such a manner, researchers may evaluate characteristics of the plants growing in the research plot, as well as characteristics of any crops produced from the plants. In some instances these characteristics may be compared to plants grown from different seed varieties in the research plot.

Traditional research seed plot planting is a largely manual process. Conventional techniques require seed samples to be packaged in small containers such as paper coin envelopes, which are manually opened at the desired planting locations in order to deposit the seed samples for planting the research plots. This is accomplished through the use of a seed planting device that is configured to carry several seed planting operators. Although seed planting devices may have a variety of configurations, many comprise a series of individual row planters that are pulled by a mobile planter transport device (such as, for example, a farm tractor, an all terrain vehicle (ATV), one or more horses, etc.). In a typical operation, seed planting operators open the paper envelopes and empty seed samples into the row planters, which deliver the seed to seed metering systems for depositing the seeds into the research seed plot.

This process is susceptible to various forms of error. For example, for a seed planting device having a plurality of row planters, this process requires a multitude of seed planting operators, who must work in tandem to accurately populate the research plot. In addition, it requires the various seed planting operators to identify the proper seed envelopes and deposit the contents of the envelopes into the seed funnel at the proper time and location. With each additional operator, however, errors of the type discussed above are multiplied. Furthermore, with each additional operator (and the additional manual operations associated therewith) the speed at which the seed planting device can move through the plot may be decreased.

As a result, there is a need in the art for a system and method that is configured to significantly reduce the manual processes involved in planting a research seed plot. In particular, the system and method should minimize the number of seed planting operators required to travel with a seed planting device. In addition, the system and method should be robust to various orientations and positions of a seed planting device in the research seed plot.

### SUMMARY OF VARIOUS EMBODIMENTS

The present invention addresses the above needs and achieves other advantages by providing a system for planting seed from a seed sample. In general, the system comprises a seed planting device having three or more individual row planters and a multi-way seed sample splitter comprising a dividing cup configured to receive the seed sample and to direct the seed sample into a plurality of openings, the openings being disposed along a perimeter of the dividing cup, the number of openings totaling a whole number multiple of the number individual row planters of the seed planting device, and a plurality of recombining chambers in communication with the openings, wherein each opening of the dividing cup has one or more associated openings creating three or more groups, and wherein each opening is located substantially equidistant from an adjacent associated opening measured along the perimeter defined by the openings, and wherein seed received into associated openings is combined together in respective recombining chambers to create three or more substantially equal divisions for delivery to respective individual row planters, irrespective of the orientation or tilt of the seed planting device. In some embodiments, the multi-way splitter of the system further comprises a receiving device configured to receive the seed sample, a release tube located proximate a bottom end of the receiving device, and a directing cone substantially centrally located below the release tube and configured to radially direct seed in a downward and outward direction, wherein the dividing cup is located below the directing cone, wherein the plurality of openings are disposed along the perimeter of the dividing cup located proximate an outer circumference thereof, and wherein the release tube is configured to operate between a first position configured to retain the seed sample and a second position configured to release seed from the seed sample into the dividing cup. In some embodiments, the first position is a lower position in which the release tube retains the seed sample within the release tube, and the second position is an upper position where the release tube releases the seed sample through an opening and into the dividing cup.

In some embodiments, the number of individual row planters is eight and the number of openings is sixteen, such that there are eight groups with two associated openings in each group, wherein the associated openings are located on opposite sides of the dividing cup, and wherein the eight groups of two associated openings are combined inside eight respective recombining chambers. In some embodiments, the release tube is pneumatically actuated to slide vertically between the lower position and the upper position. In some embodiments, the combined seed from the recombining chambers is fed via gravity to the respective individual row planters of the planting device. In some embodiments, the combined seed from the recombining chambers is fed via negative pressure to the respective individual row planters of the planting device. In some embodiments, the plurality of openings are separated by barriers that protrude vertically between each opening.

The present invention also provides a method of planting seed from a seed sample. In general the method comprises receiving seed from the seed sample in a dividing cup and directing the seed into a plurality of openings disposed along a perimeter of the dividing cup, wherein each opening of the dividing cup has one or more associated openings creating three or more groups, and wherein each opening is located substantially equidistant from an adjacent associated opening measured along the perimeter defined by the openings, combining seed received into the associated openings of each group together in respective recombining chambers to create substantially equal divisions, and delivering the divisions to respective individual row planters of a seed planting device. Some embodiments further comprise receiving the seed sample in a receiving device, directing the seed sample into a release tube, and releasing the seed sample from the release tube into the dividing cup by moving the release tube between a first position configured to retain the seed sample and a second position configured to release seed from the seed sample into the dividing cup. In some embodiments, moving the release tube between a first position and a second position comprises moving the release tube between a lower position in which the release tube retains the seed sample and an upper position in which the release tube releases the seed sample through an opening and into the dividing cup.

In some embodiments, the seed sample is directed into sixteen openings of the dividing cup that create eight groups, wherein the associated openings are located on opposite sides of the dividing cup, wherein the seed received by the sixteen openings is combined inside eight recombining chambers, and wherein the eight divisions are delivered to eight respective individual row planters. In some embodiments, the step of sliding the release cup between a lower position and an upper position occurs via pneumatic actuation. In some embodiments, the step of delivering the seed sample groups to respective individual row planters occurs via gravity. In some embodiments, the step of delivering the seed sample groups to respective individual row planters occurs via negative pressure.

### BRIEF DESCRIPTION OF THE DRAWINGS

Having thus described the invention in general terms, reference will now be made to the accompanying drawings, which are not necessarily drawn to scale, and wherein:

FIG. 1 shows a perspective view of a multi-way seed sample splitter and seed planting device that form a seed planting system in accordance with an exemplary embodiment of the present invention;

FIG. 2 shows a perspective view of various components of a multi-way seed sample splitter in accordance with an exemplary embodiment of the present invention;

FIG. 3 shows a perspective view of a receiving device, release tube, directing cone, and dividing cup of a multi-way seed sample splitter in accordance with an exemplary embodiment of the present invention;

FIG. 4 shows a top view of a dividing cup and directing cone of a multi-way seed sample splitter in accordance with an exemplary embodiment of the present invention;

FIG. 5 shows a perspective view of various components of a multi-way seed sample splitter in accordance with an exemplary embodiment of the present invention;

FIG. 6 shows a schematic view of a multi-way seed sample splitter and seed planting device that form a seed planting system in accordance with another embodiment of the present invention; and

FIG. 7 shows a ball joint for use with a multi-seed sample splitter and seed planting device in accordance with an exemplary embodiment of the present invention.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

In various embodiments, the multi-way seed sample splitter of the present invention is configured to receive a seed sample and split the seed sample into three or more substantially equal divisions. In particular, the multi-way seed sample splitter of the present invention splits the seed sample by first dividing the seed sample into a plurality of subsamples equal to a whole number multiple of the number of desired divisions and then symmetrically recombining the subsamples into the equal divisions. The divisions are then delivered to respective individual row planters of the seed planting device. By dividing the seed sample into a plurality of subsamples and then symmetrically recombining the subsamples, the multi-way seed sample splitter of the present invention may generate substantially equal divisions irrespective of the orientation or tilt of the seed planting device.

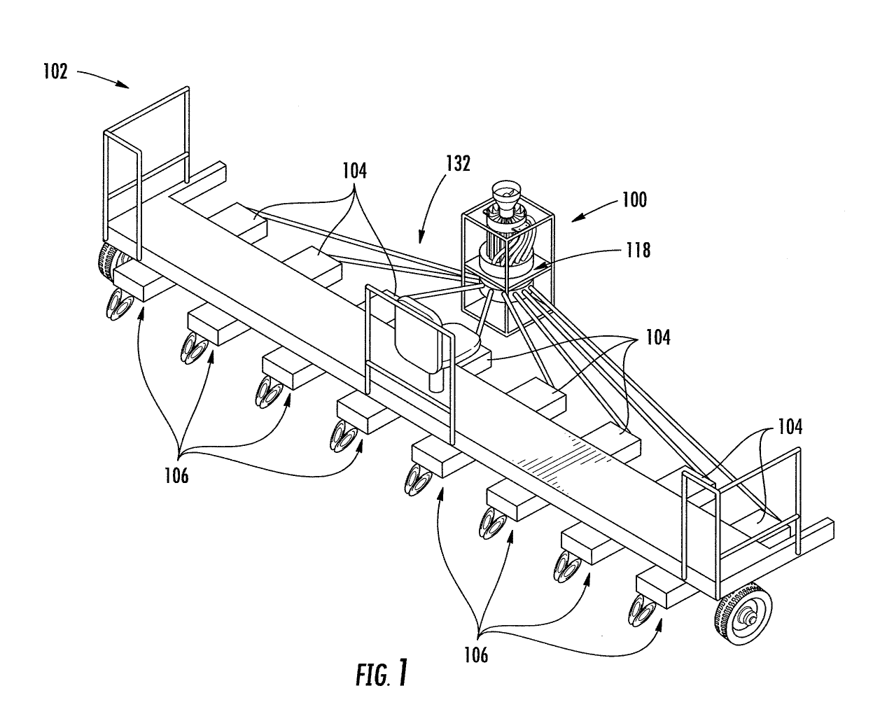

FIG. 1 shows a perspective view of a multi-way seed sample splitter 100 and seed planting device 102 that form a seed planting system in accordance with an exemplary embodiment of the present invention. (Note that for clarity purposes, various structural support elements and other components of the seed planting device 102 of FIG. 1 are not shown in the drawing). As will be discussed in more detail below, various configurations of a multi-way seed sample splitter are possible. In the depicted embodiment, the multi-way seed sample splitter 100 is an eight-way seed sample splitter and is configured for use with a seed planting device having eight individual row planters 104. It should be noted that in various embodiments the configuration of a seed planting device may vary from that depicted in the figure and thus a seed sample splitter of various embodiments of the present invention may be used with a variety of different seed planting devices. In addition, although in the depicted embodiment the seed planting device 102 has individual row planters 104 that include seed retaining gates leading to conventional seed metering devices and furrow opening and closing apparatuses 106, the present invention may be used with a variety of different seed planting and row planter designs.

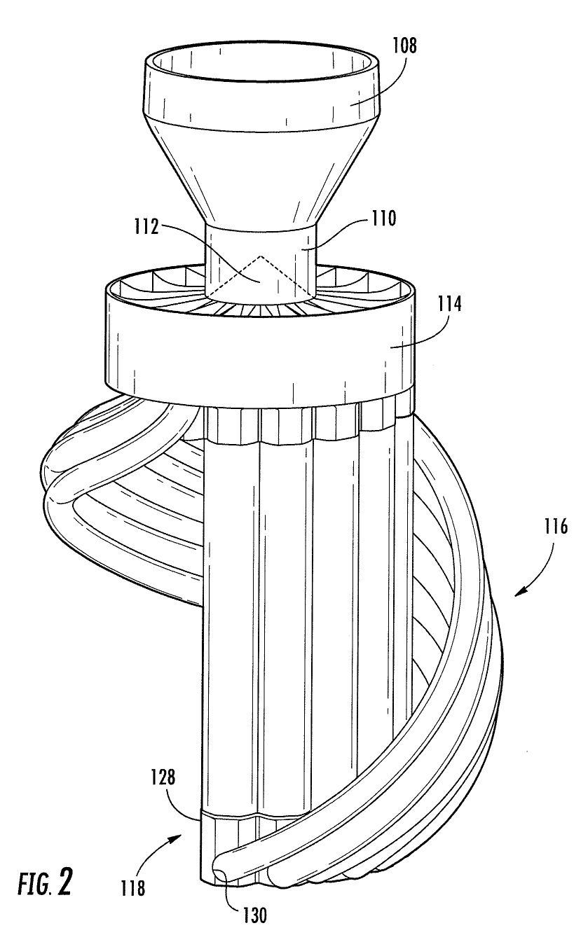

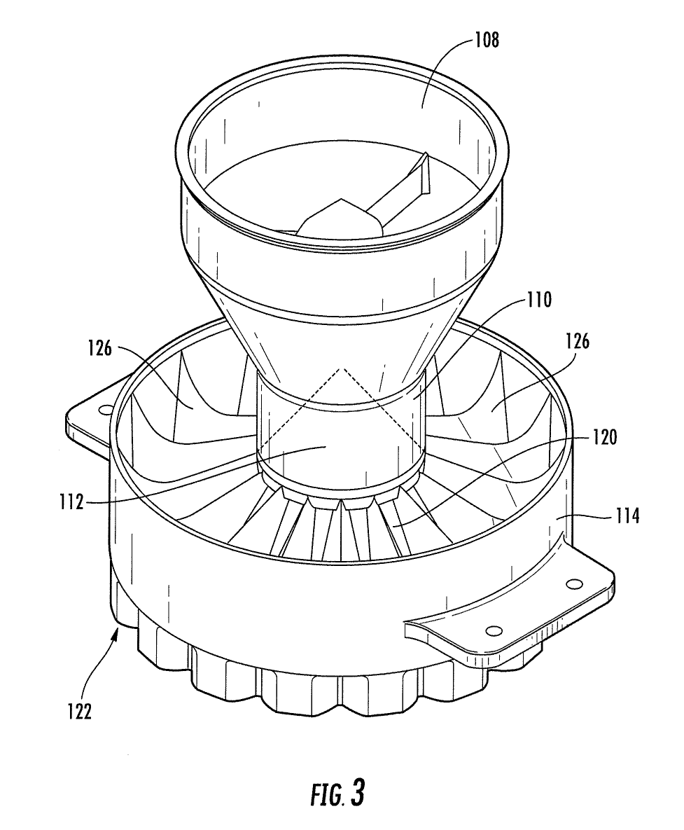

FIGS. 2 and 3 show perspective views of various components of the multi-way seed sample splitter 100 in accordance with an exemplary embodiment of the present invention. In general, the multi-way seed sample splitter 100 of the depicted embodiment includes a receiving device 108, a release tube 110, a directing cone 112, a dividing cup 114, a plurality of seed transport tubes 116, and a plurality of recombining chambers 118. It should be noted that in some embodiments, the multi-way seed sample splitter may not include a receiving device, release tube, and/or directing cone and the seed sample may be received directly into the dividing cup. In the depicted embodiment, however, the receiving device 108 is configured to receive a seed sample and to direct the seed sample into the release tube 110. Although in the depicted embodiment the receiving device 108 has a funnel design, in other embodiments the receiving device 108 may have various other configurations.

The directing cone 112 of the depicted embodiment is substantially centrally located below the release tube 110 and is oriented such that its apex is positioned upward. In such a manner, the directing cone 110 is configured to radially direct the received seed sample in a downward and outward direction. In the depicted embodiment, the release tube 110 is vertically slidable and is located proximate a bottom end of the receiving device 108. In the depicted embodiment, the release tube 110 is configured to slide between a lower position and an upper position. In the lower position, the lower portion of the release tube 110 contacts a top surface of the directing cone 112 such that any seeds received by the receiving device 108 are contained in the release tube 110. (Note that the release tube 110 of FIGS. 2 and 3 is shown in the lower position.) In the upper position, a lower end of the release tube 110 does not contact a top surface of the directing cone 112. Thus, when the release tube 110 is moved to the upper position, a radial opening is created between the release tube 110 and the directing cone 112. In such a manner, seed from the seed sample contained in the release tube 110 is directed via gravity downward and outward into the dividing cup 114. In the depicted embodiment, the release tube 110 moves to and from the lower and upper positions via a pneumatic cylinder (not shown), however in other embodiments the release tube 110 may be actuated in a variety of different ways, including via other automatic means and/or through manual actuation. In addition, although in the depicted embodiment the release tube 110 moves vertically from a lower position to an upper position to release seed from the seed sample, in other embodiments the release tube 110 may release seed from the seed sample in various different ways.

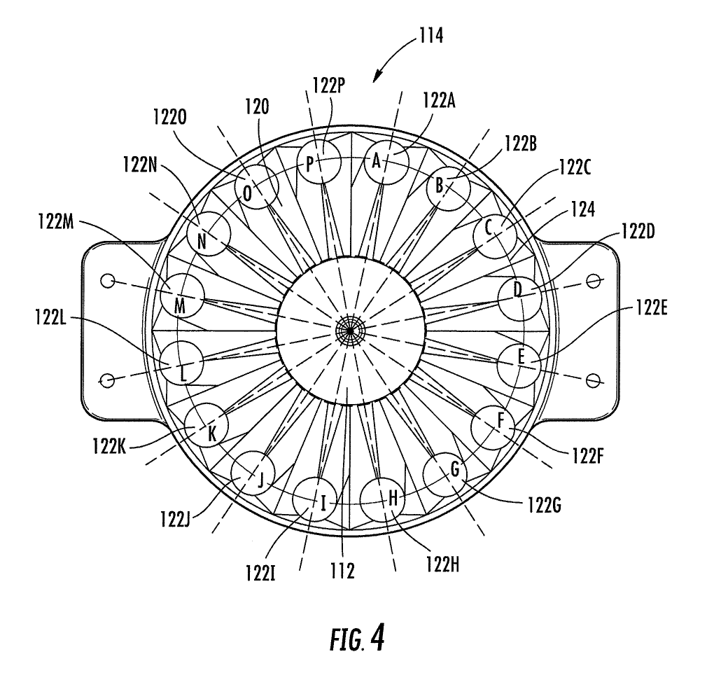

FIG. 4 shows a top view of the dividing cup 114 and directing cone 112 in accordance with an exemplary embodiment of the present invention. The dividing cup 114 of the depicted embodiment is located below the directing cone 112 and includes a directing surface 120 that is configured to radially direct seed received from the release tube 110 toward an outer circumference of the dividing cup 114 and into a plurality of openings 122 that are disposed along a perimeter 124 proximate the outer circumference. Although in various embodiments the openings 122 may comprise slots and/or may have a variety of shapes and sizes (including, but not limited to, substantially circular, elliptical, square, rectangular, and triangular shapes), in the depicted embodiment the openings 122 are substantially circular in shape. In the depicted embodiment, there are sixteen openings 122A-122P substantially equally spaced along the perimeter 124. The openings 122 are separated by barriers 126 that protrude vertically between each opening 122. (Note that barriers 126 are more visible in FIG. 3).

It should be noted that although in the depicted embodiment the plurality of openings 122 are disposed along a single perimeter 124 proximate an outer circumference of the dividing cup 114, in other embodiments the plurality of openings 122 may be disposed in a different location within the dividing cup 114 (such as, for example, between the outer circumference and the directing cone 112). In additional embodiments, the plurality of openings 122 may be disposed along two or more perimeters that have different locations within the dividing cup 114. For example, in one embodiment a first plurality of openings may be disposed along one perimeter that is located proximate an outer circumference of the dividing cup, and a second plurality of openings may be disposed along another perimeter located between the outer circumference of the dividing cup and the directing cone. In addition, in some embodiments gates may be configured to block one or more of openings to allow selective use thereof.

Although in the depicted embodiment, the dividing cup 114 and the directing cone 112 are separate parts, in other embodiments they may comprise the same part. In addition, although the top surface of the directing cone 112 of the depicted embodiment is substantially smooth, in other embodiments the directing cone 112 or any portions thereof may have other configurations. For example, in some embodiments all or a portion of the top surface of the directing cone 112 may be scalloped or otherwise shaped to match the profile of the directing surface 120 of the dividing cup 114. Furthermore, although in the depicted embodiment the barriers 126 of the dividing cup 114 comprise a plurality of fins that extend from the directing surface 120 between each opening 122, in various other embodiments the barriers may have other configurations. In still other embodiments, there may not be any barriers.

In general, the present invention is configured to split a seed sample into substantially equal divisions for delivery to the individual row planters 104 of the seed planting device 102 by dividing the seed sample into a plurality of subsamples equal to a whole number multiple of the desired number of divisions and then symmetrically recombining the subsamples prior to delivering the divisions to the individual row planters 104. In various embodiments, the openings 122 of the dividing cup 114 are grouped into associated opening groups, with each group having a number of associated openings 122 equal to the whole number multiplier of the desired number of divisions. Each associated opening 122 is substantially equidistant from an adjacent associated opening 122 measured along the perimeter 124 defined by the openings 122 such that the openings are grouped substantially symmetrically, and, for each opening group, the seed received by the associated openings 122 is recombined downstream to create divisions that are approximately equal plus or minus a tolerance. In such a manner, the present invention creates a symmetric recombination of a plurality of subsamples, which compensates for orientation and tilt variations of the seed sample splitter 100 and may be resistant to variations caused by the movement and vibrations of the seed planting device 102 as it travels.

In the depicted embodiment there are eight desired divisions and there are eight individual row planters 104 on the seed planting device 102. Thus, referring to FIG. 4, there are eight associated opening groups. In the depicted embodiment, the whole number multiplier is two, therefore the dividing cup 114 has sixteen separate openings 122A-122P, with each opening group having two associated openings 122. Since each associated opening 122 is equidistant from an adjacent associated opening 122 and because there are only two associated openings 122 in each group, the associated openings 122 of the depicted embodiment are located on opposite sides of the dividing cup 114. In particular, for the dividing cup 114 of the depicted embodiment the associated opening groups are as follows: 122A and 122I; 122B and 122J; 122C and 122K; 122D and 122L; 122E and 122M; 122F and 122N; 122G and 122O; 122H and 122P.

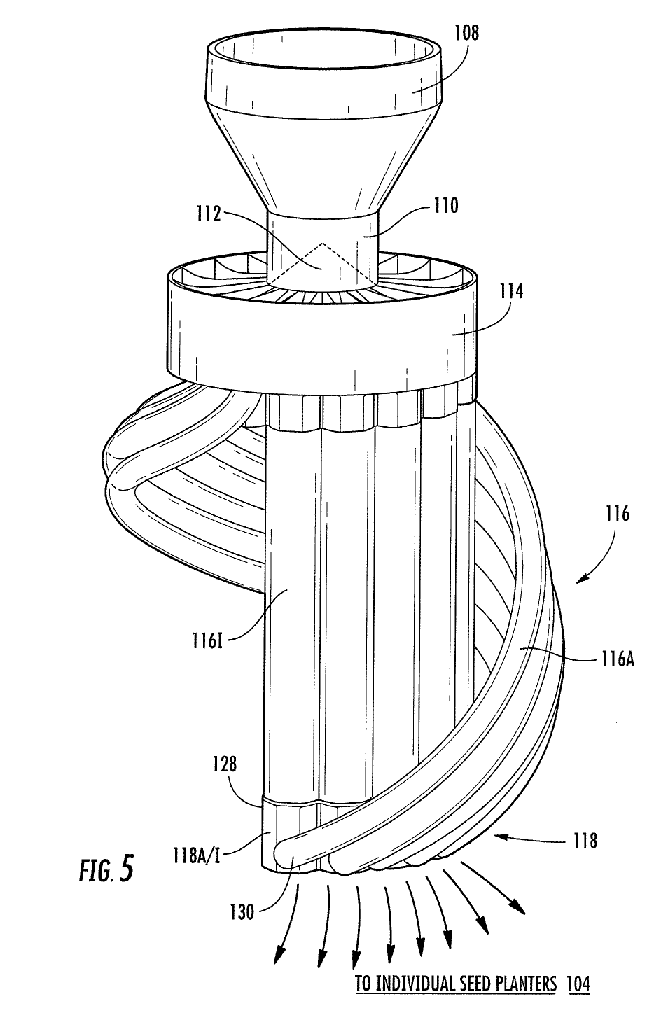

Seed received by the associated openings 122 of the opening groups is recombined downstream to create the substantially equal divisions. FIG. 5 shows a perspective view of various components of the multi-way seed sample splitter 100 in accordance with an exemplary embodiment of the present invention. As shown in the drawing, in the depicted embodiment there are eight recombining chambers 118 that receive seed from the respective associated openings 122 through seed transport tubes 116. In the depicted embodiment, the recombining chambers 118 comprise devices that include a first inlet 128 configured to receive seed from one of the associated openings 122 and a second inlet 130 configured to receive seed from the other associated opening 122. In the depicted embodiment, seed from the associated openings 122 is delivered to respective recombining chambers 118 through sixteen seed transport tubes 116 via gravity. For example, recombining chamber 118A/I receives seed from opening 122I through seed transport tube 116I via the first inlet 128 and receives seed from opening 122A through seed transport tube 116A via the second inlet 130, and so on for the remaining recombining chambers 118. Although in various embodiments the seed transport tubes 116 may have a variety of different configurations, in the depicted embodiment half of the seed transport tubes 116 comprise substantially rigid tubes (e.g., 116I) that extend vertically downward and the other half of the seed transport tubes 116 comprise flexible tubes (e.g., 116A) that extend around the seed sample splitter 100 to reach the respective recombining chambers 118. It should be noted that although in the depicted embodiment seed travels through the seed transport tubes 116 via gravity, in other embodiments seed may travel by other means, including, but not limited to, being propelled or being moved by mechanical means.

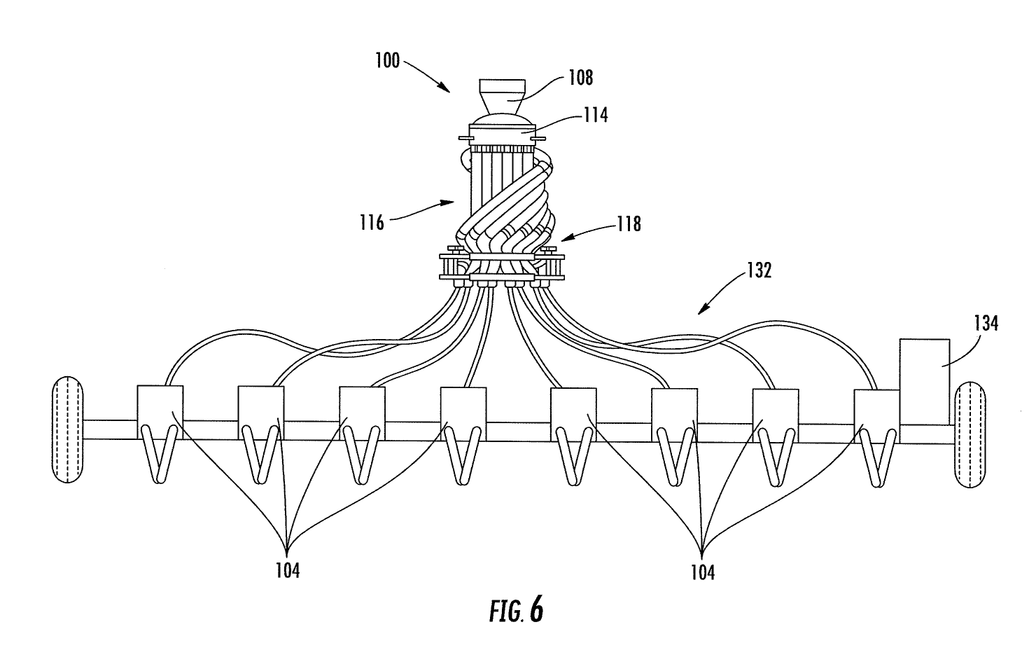

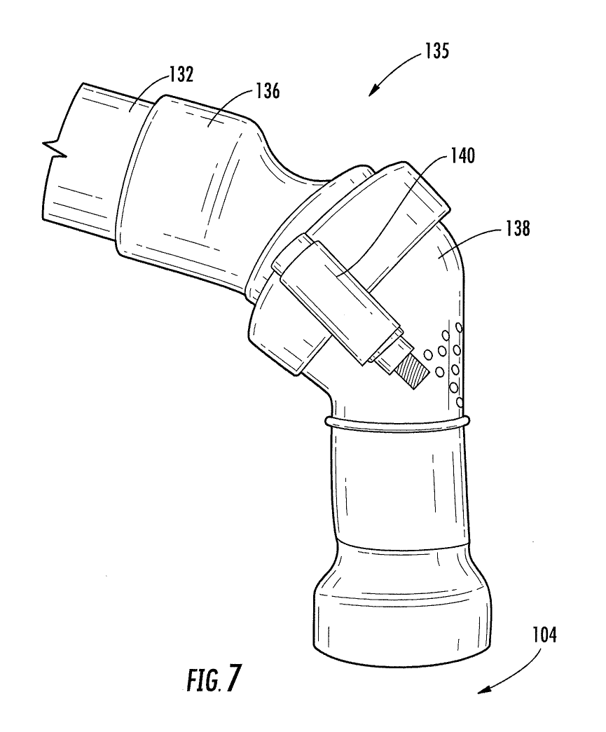

In the depicted embodiment, once seed from the groups of associated openings is recombined in the recombining chambers 118, it is delivered to respective individual row planters 104 of the seed planting device 102. In various embodiments the seed may be delivered in a variety of ways. For example, referring to FIG. 1, in one embodiment seed may be delivered from the recombining chambers 118 to the individual row planters 104 through seed delivery tubes 132 via gravity. Referring to FIG. 6, in another embodiment seed may be delivered from the recombining chambers 118 to the individual row planters 104 through seed delivery tubes 132 via negative pressure generated by one or more vacuum devices 134. (Note that for clarity purposes, various structural support elements and other components of the seed planting device 102 of FIG. 6 are not shown in the drawing). In some embodiments, a seed delivery tube 132 may be connected to a respective individual row planter 104 using a ball joint 135 as shown in FIG. 7. In various embodiments, the ball joint 135 may be comprised of a first member 136 that is configured to rotate about a second member 138. In the depicted embodiment, the first member 136 is connected to the seed delivery tube 132 and the second member 138 is connected to the row planter 104. One or more locking mechanisms 140 may also be included to secure the first and second members 136, 138 at various angles with respect to each other. In such a manner, the ball joint 135 may be used with seed delivery tube-row planter interfaces having a variety of different relative angles.

In some embodiments, the seed from the recombining chambers may be further combined one or more additional times so as to accommodate seed planting devices having different numbers of individual seed planters with the same seed sample splitter. In one embodiment, for example, seed from respective pairs of eight recombining chambers may be further combined such that the same seed sample splitter 100 having eight recombining chambers shown in FIG. 2 (that is described above for use with a seed planting device having eight individual row planters) may be used for a seed planting device having four individual row planters. As such, the seed sample splitter 100 of the depicted embodiment may be modular in design such that the same seed sample splitter 100 may be removable from a seed planting device having one configuration and attachable to a seed planting device having another configuration.

It should be noted that in various embodiments, the seed delivery tubes 132 and/or the seed transport tubes 116 may have a variety of different configurations and may be substantially rigid or substantially flexible. In addition, although in the depicted embodiment seed travels through the seed delivery tubes 132 via negative pressure, in other embodiments seed may travel by other means, including, but not limited to, being propelled or being moved by mechanical or pneumatic means. Although in the depicted embodiment the seed transport tubes 116 and seed delivery tubes 132 have a substantially circular cross-sectional shape, in various other embodiments some or all of the seed transport tubes 116 and/or the seed delivery tubes 132 may have other cross-sectional shapes (including, but not limited to, elliptical, square, rectangular, and triangular cross-sectional shapes). In various embodiments, the seed sample splitter may be configured to substantially reduce or eliminate seed contamination and/or carryover from one seed planting event to next. Thus, in some embodiments the seed transport tubes 116 and/or the seed delivery tubes 132 may be configured such that they are free of ledges or other features that may tend to prohibit seed travel through the seed transport tubes 116, 132 or to cause seed to be stuck in the tubes 116, 132.

Although the depicted embodiment shows eight opening groups with two associated openings 122 in each group, in various other embodiments, there may be a variety of different opening group configurations designed for use with seed planting devices having a range of numbers of individual row planters, including, but not limited to, seed planting devices having three individual row planters to seed planting devices having sixteen individual row planters or more. For example, in one embodiment of the present invention, the seed planting device may have four individual row planters and the dividing cup may have eight openings formed into four groups with two associated openings in each group. Because each associated opening is positioned substantially equidistant from an adjacent associated opening measured along the perimeter defined by the openings, the associated openings of such a configuration may be positioned on opposite sides of the dividing cup in such a configuration. In another embodiment, the seed planting device may have four individual row planters and the dividing cup may have twelve openings formed into four groups with three associated openings in each group. Because each associated opening is positioned substantially equidistant from an adjacent associated opening measured along the perimeter defined by the openings, the associated openings of such a configuration may be positioned approximately 120 degrees from each other along the perimeter defined by the openings. The above are only a few of the many possible combinations provided by the present invention using three or more opening groups and multipliers of 2, 3, 4, 5, . . . , etc., and thus the present invention should not be limited to any of the examples presented herein.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for planting seed from a seed sample, said system comprising:
a seed planting device having three or more individual row planters; and
a multi-way seed sample splitter comprising:
a dividing cup configured to receive the seed sample and to direct the seed sample into a plurality of openings, the openings being disposed along a perimeter of the dividing cup, the number of openings totaling a whole number multiple of the number individual row planters of the seed planting device; and
a plurality of recombining chambers in communication with the openings,
wherein each opening of the dividing cup has one or more associated openings creating three or more groups, and wherein each opening is located substantially equidistant from an adjacent associated opening measured along the perimeter defined by the openings, and wherein seed received into associated openings is combined together in respective recombining chambers to create three or more substantially equal divisions for delivery to respective individual row planters, irrespective of the orientation or tilt of the seed planting device.

2. The system of claim 1, wherein the multi-way seed sample splitter of the system further comprises:
a receiving device configured to receive the seed sample;
a release tube located proximate a bottom end of the receiving device; and
a directing cone substantially centrally located below the release tube and configured to radially direct seed in a downward and outward direction,
wherein the dividing cup is located below the directing cone, wherein the plurality of openings are disposed along the perimeter of the dividing cup located proximate an outer circumference thereof, and wherein the release tube is configured to operate between a first position configured to retain the seed sample and a second position configured to release seed from the seed sample into the dividing cup.

3. The system of claim 2, wherein the first position is a lower position in which the release tube retains the seed sample within the release tube, and the second position is an upper position where the release tube releases the seed sample through an opening and into the dividing cup.

4. The system of claim 1, wherein the number of individual row planters is eight and the number of openings is sixteen, such that there are eight groups with two associated openings in each group, wherein the associated openings are located on opposite sides of the dividing cup, and wherein the eight groups of two associated openings are combined inside eight respective recombining chambers.

5. The system of claim 3, wherein the release tube is pneumatically actuated to slide vertically between the lower position and the upper position.

6. The system of claim 1, wherein the combined seed from the recombining chambers is fed via gravity to the respective individual row planters of the planting device.

7. The system of claim 1, wherein the combined seed from the recombining chambers is fed via negative pressure to the respective individual row planters of the planting device.

8. The system of claim 1, wherein the plurality of openings are separated by barriers that protrude vertically between each opening.

9. A method of planting seed from a seed sample, said method comprising:
receiving seed from the seed sample in a dividing cup of a multi-well seed sample splitter and directing the seed into a plurality of openings disposed along a perimeter of the dividing cup, wherein each opening of the dividing cup has one or more associated openings creating three or more groups, and wherein each opening is located substantially equidistant from an adjacent associated opening measured along the perimeter defined by the openings;
combining seed received into the associated openings of each group together in respective recombining chambers to create substantially equal divisions; and
delivering the divisions to respective individual row planters of a seed planting device.

10. The method of claim 9, further comprising:
receiving the seed sample in a receiving device;
directing the seed sample into a release tube; and
releasing the seed sample from the release tube into the dividing cup by moving the release tube between a first position configured to retain the seed sample and a second position configured to release seed from the seed sample into the dividing cup.

11. The method of claim 10, wherein moving the release tube between a first position and a second position comprises moving the release tube between a lower position in which the release tube retains the seed sample and an upper position in which the release tube releases the seed sample through an opening and into the dividing cup.

12. The method of claim 9, wherein the seed sample is directed into sixteen openings of the dividing cup that create eight groups, wherein the associated openings are located on opposite sides of the dividing cup, wherein the seed received by the sixteen openings is combined inside eight recombining chambers, and wherein the eight divisions are delivered to eight respective individual row planters.

13. The method claim 11, wherein the step of sliding the release cup between a lower position and an upper position occurs via pneumatic actuation.

14. The method of claim 9, wherein the step of delivering the seed sample groups to respective individual row planters occurs via gravity.

15. The method of claim 9, wherein the step of delivering the seed sample groups to respective individual row planters occurs via negative pressure.
